(19) United States
(12) Patent Application Publication
(10) Pub. No.: US 2024/0296186 A1
(43) Pub. Date: Sep. 5, 2024

(54) LANGUAGE MODELS AND MACHINE LEARNING FRAMEWORKS FOR FACILITATING INTERACTIONS BETWEEN END-USERS AND MULTIPLE SERVICE PROVIDER PLATFORMS

(71) Applicant: SurgeTech, LLC, Austin, TX (US)

(72) Inventors: Michael Love, Marble Falls, TX (US); Blake Love, Austin, TX (US); Tiago Soromenho, Austin, TX (US)

(21) Appl. No.: 18/116,709

(22) Filed: Mar. 2, 2023

(51) Int. Cl. G06F 16/9032; G06F 9/451

(52) U.S. Cl. CPC G06F 16/90332; G06F 9/451

(57) ABSTRACT

This disclosure relates to improved techniques for accessing and presenting service offerings and/or services options from multiple service provider platforms. In some embodiments, a front-end of the user application includes a client interface that enables an end-user to communicate with a pre-trained language model. The language model can serve as an intermediary between the end-user and a plurality of service provider platforms. The language model can communicate with each of the of service provider platforms to identify and present service options to the end-user via the client interface. Other embodiments are disclosed herein as well.

### TECHNICAL FIELD

This disclosure is related to improved systems, methods, and techniques for utilizing pre-trained language models to communicate with multiple service provider platforms in connection with fulfilling requests submitted by end-users. In certain embodiments, one or more generative pre-trained transformer models can be executed to interact with end-users and obtain service options from multiple service provider platforms.

### BACKGROUND

End-users can install and utilize service provider applications on mobile devices (and other types of computing devices) to obtain various types of service offerings. For example, in some instances, a service provider application can enable an end-user to schedule a driver or vehicle for a ride. In other examples, a service provider application can enable an end-user to book lodging (e.g., a room at a hotel, motel, home stay, etc.). Many other types of service offerings also can be provided via the service provider applications.

In many cases, a single end-user will download and install multiple service provider applications that provide the same type of service offering. For example, the end-user may install multiple ride sharing applications, each of which is associated with a different service provider platform or company. When the end-user is seeking to schedule a ride, the end-user may wish to compare service options (e.g., ride options with varying prices, pickup times, vehicle types, etc.) that are available for each of the ride sharing applications. This typically requires the end-user to separately open each application, enter desired parameters (e.g., destination, pickup location, etc.) into each application, and view the service options available through each application. This process of manually comparing the service options provided by each of the applications can be tedious and can frustrate the user experience. Additionally, while the end-user is switching between applications to compare the service options, the service options are liable to change (e.g., the prices can change and/or certain rides can become unavailable because they are taken by other end-users).

### BRIEF DESCRIPTION OF DRAWINGS

To facilitate further description of the embodiments, the following drawings are provided, in which like references are intended to refer to like or corresponding parts, and in which:

FIG. 1A is a diagram of an exemplary system in accordance with certain embodiments;

FIG. 1B is a block diagram demonstrating exemplary features of an application platform in accordance with certain embodiments;

FIG. 2 is a block diagram illustrating an exemplary process flow for presenting an end-user with service options in accordance with certain embodiments;

FIG. 3 is a block diagram demonstrating exemplary features of a service provider platform in accordance with certain embodiments;

FIG. 4A is an illustration demonstrating multiple service provider applications for single service offering being installed on a computing device of an end-user;

FIG. 4B is another illustration demonstrating multiple service provider applications for single service offering being installed on a computing device of an end-user;

FIG. 4C is an illustration showing an end-user switching among multiple service provider applications to compare service options for a single service offering;

FIG. 5A is an illustration showing an exemplary exchange between an end-user and a language model in accordance with certain embodiments;

FIG. 5B is an illustration showing another exemplary exchange between an end-user and a language model in accordance with certain embodiments;

FIG. 5C is an illustration showing another exemplary exchange between an end-user and a language model in accordance with certain embodiments; and

FIG. 6 is a flowchart illustrating an exemplary method in accordance with certain embodiments.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein.

The terms “left,” “right,” “front,” “rear,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

As used herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

Certain data or functions may be described as “real-time,” “near real-time,” or “substantially real-time” within this disclosure. Any of these terms can refer to data or functions that are processed with a humanly imperceptible delay or minimal humanly perceptible delay. Alternatively, these terms can refer to data or functions that are processed within a specific time interval (e.g., in the order of milliseconds).

### DETAILED DESCRIPTION OF EXEMPLARY EMBODIMENTS

The present disclosure relates to systems, methods, apparatuses, computer program products, and techniques for using artificial intelligence (AI) or machine learning language models to interact with multiple service provider platforms to respond to end-user requests. In certain embodiments, a user application includes a client interface that enables an end-user to interact with a language model. The end-user can submit various types of user requests to the language model via the client interface. In response to receiving a user request, the language model can initiate a communication exchange with a plurality of service provide platforms to generate outputs responsive to the user request.

In certain embodiments, an end-user can interact with the language model via the client interface in connection with a service offering. Amongst other things, the end-user can interact with the language model to understand available service options pertaining to the service offering, and to place orders for the service offering based on desired service options. In response to receiving a user request, the language model can initiate a communication exchange with a plurality of service platform providers that offer the service offering to identify service options associated with the service offering. The service options can be output to the end-user via the client interface.

Traditionally, an end-user is required to access separate service provider applications and manually compare service options to schedule a service offering. In certain embodiments, the language model can serve as an intermediary that is situated between the client interface included on a front-end of the user application and a plurality of service provider platforms. The language model can translate and discern the meaning or intention of inputs received via the client interface, and communicate with each of the service provider platforms to respond to user requests and/or other inputs provided by end-users via the client interface. This avoids the end-user having to manually access and compare service options offered by various service provider platforms.

End-users can interact with the language model to obtain information, and place orders for, any type of service offering. In general, the service offerings can generally correspond to any type of product and/or service. In some examples, the service offerings can correspond to ride hailing or ride sharing services, lodging or accommodation booking services, transportation booking services (e.g., that permit individuals to book or schedule transportation with airlines, trains, buses, boats, cruises, etc.), online marketplaces, and/or reservation scheduling services. Many other types of service offerings also can be provided via the user application.

In certain scenarios, the language model can be configured to communicate with a plurality of service provider platforms to generate multi-platform responses. Generally speaking, a multi-platform response can represent a response that is generated based, at least in part, on communications with two or more service provider platforms. Some examples of multi-platform responses described herein relate to service options and/or service offerings provided by multiple service provider platforms. However, other types of the multi-platform responses also can be generated that do not necessarily involve service options and/or service offerings.

In some scenarios, a multi-platform response can present end-users with a summary of available service options to enable the end-user to review and select a desired service option. Additionally, or alternatively, a multi-platform response can present a single service option that is determined or predicted by the language model to be the most optimal service option for an end-user. For example, the language model can learn user preferences of an end-user with respect to service options based on historical interactions with the language model and/or service provider applications, and this knowledge can be leveraged by the learning model to generate a multi-platform response identifying or predicting a single service option that is optimal for the end-user. Additionally, in some embodiments, the language model can automatically schedule or place an order for a service offering or service item due to a comprehensive understanding of the end-user's preferences and/or activity patterns. In this manner, the language model can eliminate, or at least minimize, decision-making on the part of the end-user. This can be beneficial to avoid inconveniencing the end-user with having to analyze and compare various service options from multiple service providers.

Additionally, in some embodiments, the language model can execute a preemptive analysis function that is configured to initiate interactions with end-users via the client interface without being prompted by an end-user (e.g., without receiving a user request via the client interface). For example, in some scenarios, the language model can learn activity patterns of end-users to detect or predict scenarios when an end-user will likely desire a particular service offering. In these scenarios, the preemptive analysis function can automatically initiate communication exchanges with a plurality of service provider platforms to understand available service options relating to the service offering likely desired be the end-user. The language model can then generate a multi-platform response that is output via the client interface to present the end-user with one or more service options. These preemptive multi-platform responses can be personalized in the same manner discussed in other portions of this disclosure. In this manner, the preemptive analysis function is able to intuitively provide end-users with service offerings (or corresponding service options) without requiring the end-user to provide a single input via the client interface or interact with the language model in any manner.

The configuration of the language model can vary. In some embodiments, the language model can include one or more generative pre-trained transformer (GPT) models (e.g., a GPT-1, GPT-2, GPT-3, or subsequently developed GPT model). Additionally, or alternatively, the language model can include one or more

BERT (Bidirectional Encoder Representations from Transformers) models, one or more XLNet models, one or more RoBERTa (Robustly Optimized BERT pre-training approach) model, and/or one or more T5 (Text-to-Text Transfer Transformer) models. Additionally, in some scenarios, the language model can represent a single model and, in other scenarios, the language model can be comprised of multiple learning models that cooperate together.

As explained below, various training procedures can be applied to the language model. In certain embodiments, a self-supervised training procedure can initially be applied to train the language model on a training dataset that is derived from a text corpus accumulated from multiple sources, such as web pages, books, academic articles, news articles, and/or other text-based works. Additionally, a transfer learning procedure can be applied subsequently to train the language model using one or more domain-specific datasets, each of which comprises textual content relating to a service offering and/or service options corresponding to the service offering. The learning model also can be trained with one or more datasets that include textual content corresponding to historical end-user interactions with the language model, as well as service offerings, service options, and/or features of the user application (or service provider applications). Training the language model with domain-specific textual content improves the accuracy of the language model and permits the language model to respond more effectively to inputs provided by end-users.

The systems and methods described herein include a technological framework that provides a variety of benefits and advantages. Amongst other things, AI and machine learning technologies can be utilized to interact with both the end-users and various service provider platforms. In some embodiments, these technologies can improve user experiences with placing orders for service offerings and/or obtaining service options relating to the service offerings. In some embodiments, improved training procedures can be applied to increase the accuracy and usefulness of responses provided by the language model. The enhanced functionality of the language models can be attributed, at least in part, to the usage of domain-specific datasets to supplement the training of the language model. Additionally, in some embodiments, the improved functionality of the language model also can be attributed, at least in part, to a continuous learning framework that enables the language model to learn continuously over time based on interactions with the end-users. In some embodiments, this continuous learning framework also can enable the language model to discern various individualized preferences for each of the end-users based on historical interactions with the end-users. The continuous learning framework also can learn use activity patterns of end-users to enable the language model to preemptively interact with end-users and present service options to the end-users.

The technologies described herein provide many additional benefits and advantages. One advantage is that end-users can communicate with a language model to obtain service options corresponding to a service offering from a plurality of different service provider platforms. Another advantage is that the service options can be personalized or customized to each of the end-users based on parameters included in inputs and/or based on historical interactions with the end-users. For example, in some cases, the service options can be personalized or customized based on pricing thresholds and/or other preferences of the end-users. Moreover, in some scenarios, the language model can analyze multiple available service options (e.g., offered by multiple service provider platforms) and determine or predict an optimal service option for an end-user, which can be presented to the end-user and/or utilized by the language model to automatically place an order for the optimal service option. This can be advantageous in bypassing or avoiding the need for the end-user to conduct a comparative analysis of available the service options. Many other advantages will be apparent based on a review of this disclosure.

Additional benefits can be attributed to embodiments in which the service provider platforms execute surge pricing functions to price service offerings and/or service options corresponding to the service offerings. Service provider platforms that employ surge pricing functionalities can better mitigate imbalances between an available supply of inventory items and a demand for those inventory items. The surge pricing functionalities can dynamically adjust prices for the service offerings, thereby enabling service providers of the user applications to reduce high-demand peaks. Additionally, in scenarios where demand is high and/or increased pricing rates are being applied to the service offerings, the language model can help end-users identify the best available service options across all of the service provider platforms.

The embodiments described in this disclosure can be combined in various ways. Any aspect or feature that is described for one embodiment can be incorporated to any other embodiment mentioned in this disclosure. Moreover, any of the embodiments described herein may be hardware-based, may be software-based, or, preferably, may comprise a mixture of both hardware and software elements. Thus, while the description herein may describe certain embodiments, features, or components as being implemented in software or hardware, it should be recognized that any embodiment, feature and/or component referenced in this disclosure can be implemented in hardware and/or software.

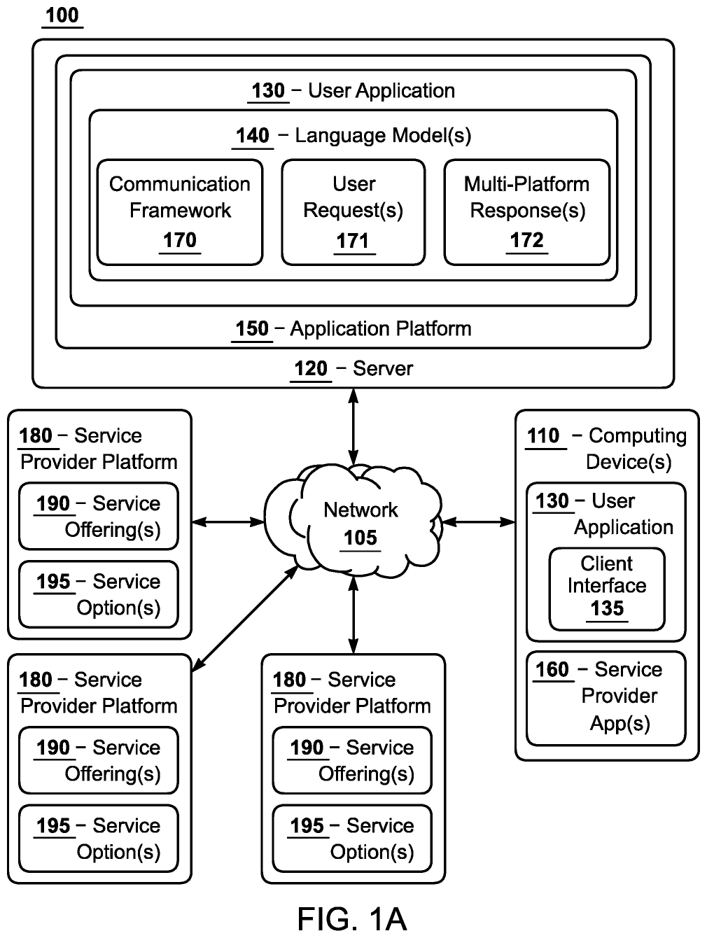

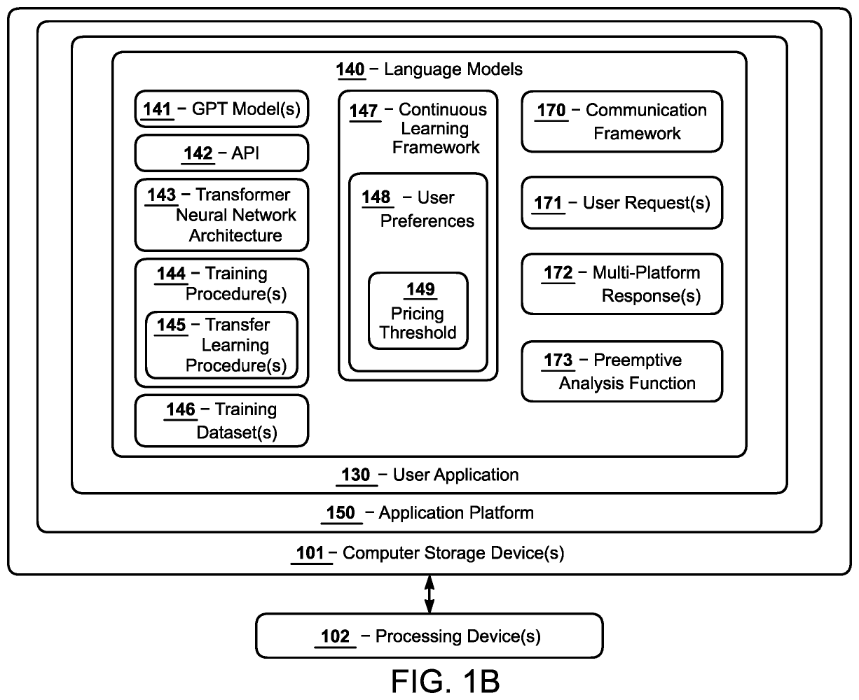

FIG. 1A is a diagram of an exemplary system 100 in accordance with certain embodiments. FIG. 1B is a diagram illustrating exemplary features and/or functions associated with an application platform 150.

The system 100 comprises one or more computing devices 110, one or more servers 120, and one or more service provider platforms 180 that are in communication over a network 105. An application platform 150 is stored on, and executed by, the one or more servers 120. The network 105 may represent any type of communication network, e.g., such as one that comprises a local area network (e.g., a Wi-Fi network), a personal area network (e.g., a Bluetooth network), a wide area network, an intranet, the Internet, a cellular network, a television network, and/or other types of networks.

All the components illustrated in FIG. 1A, including the computing devices 110, servers 120, application platform 150, and service provider platforms 180 can be configured to communicate directly with each other and/or over the network 105 via wired or wireless communication links, or a combination of the two. Each of the computing devices 110, servers 120, application platform 150, and service provider platforms 180 can include one or more communication devices, one or more computer storage devices 101, and one or more processing devices 102 that are capable of executing computer program instructions.

The one or more processing devices 102 may include one or more central processing units (CPUs), one or more microprocessors, one or more microcontrollers, one or more controllers, one or more complex instruction set computing (CISC) microprocessors, one or more reduced instruction set computing (RISC) microprocessors, one or more very long instruction word (VLIW) microprocessors, one or more graphics processor units (GPU), one or more digital signal processors, one or more application specific integrated circuits (ASICs), and/or any other type of processor or processing circuit capable of performing desired functions. The one or more processing devices 102 can be configured to execute any computer program instructions that are stored or included on the one or more computer storage devices including, but not limited to, instructions associated with executing the functions associated with the user application 130, language model 140, and/or application platform 150.

The one or more computer storage devices may include (i) non-volatile memory, such as, for example, read only memory (ROM) and/or (ii) volatile memory, such as, for example, random access memory (RAM). The non-volatile memory may be removable and/or non-removable non-volatile memory. Meanwhile, RAM may include dynamic RAM (DRAM), static RAM (SRAM), etc. Further, ROM may include mask-programmed ROM, programmable ROM (PROM), one-time programmable ROM (OTP), erasable programmable read-only memory (EPROM), electrically erasable programmable ROM (EEPROM) (e.g., electrically alterable ROM (EAROM) and/or flash memory), etc. In certain embodiments, the storage devices 101 may be physical, non-transitory mediums. The one or more computer storage devices can store instructions associated with executing the functions associated with the user application 130, language model 140, and/or application platform 150.

Each of the one or more communication devices can include wired and wireless communication devices and/or interfaces that enable communications using wired and/or wireless communication techniques. Wired and/or wireless communication can be implemented using any one or combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). Exemplary PAN protocol(s) can comprise Bluetooth, Zigbee, Wireless Universal Serial Bus (USB), Z-Wave, etc. Exemplary LAN and/or WAN protocol(s) can comprise Institute of Electrical and Electronic Engineers (IEEE) 802.3 (also known as Ethernet), IEEE 802.11 (also known as WiFi), etc. Exemplary wireless cellular network protocol(s) can comprise Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc. The specific communication software and/or hardware can depend on the network topologies and/or protocols implemented. In certain embodiments, exemplary communication hardware can comprise wired communication hardware including, but not limited to, one or more data buses, one or more universal serial buses (USBs), one or more networking cables (e.g., one or more coaxial cables, optical fiber cables, twisted pair cables, and/or other cables). Further exemplary communication hardware can comprise wireless communication hardware including, for example, one or more radio transceivers, one or more infrared transceivers, etc. Additional exemplary communication hardware can comprise one or more networking components (e.g., modulator-demodulator components, gateway components, etc.). In certain embodiments, the one or more communication devices can include one or more transceiver devices, each of which includes a transmitter and a receiver for communicating wirelessly. The one or more communication devices also can include one or more wired ports (e.g., Ethernet ports, USB ports, auxiliary ports, etc.) and related cables and wires (e.g., Ethernet cables, USB cables, auxiliary wires, etc.).

In certain embodiments, the one or more communication devices additionally, or alternatively, can include one or more modem devices, one or more router devices, one or more access points, and/or one or more mobile hot spots. For example, modem devices may enable the computing devices 110, server(s) 120, application platform 150, and/or service provider platforms 180 to be connected to the Internet and/or other network. The modem devices can permit bi-directional communication between the Internet (and/or other networks) and the computing devices 110, server(s) 120, application platform 150, and/or service provider platforms 180. In certain embodiments, one or more router devices and/or access points may enable the computing devices 110, server(s) 120, application platform 150, and/or service provider platforms 180 to be connected to a LAN and/or other more other networks. In certain embodiments, one or more mobile hot spots may be configured to establish a LAN (e.g., a Wi-Fi network) that is linked to another network (e.g., a cellular network). The mobile hot spot may enable the computing devices 110, server(s) 120, application platform 150, and/or service provider platforms 180 to access the Internet and/or other networks.

In certain embodiments, the computing devices 110 may represent mobile devices (e.g., smart phones, personal digital assistants, tablet devices, vehicular computing devices, wearable devices, or any other device that is mobile in nature), desktop computers, laptop computers, and/or other types of devices. The one or more servers 120 may generally represent any type of computing device, including any of the computing devices 110 mentioned above. The one or more servers 120 also can comprise one or more mainframe computing devices and/or one or more virtual servers that are executed in a cloud-computing environment. In some embodiments, the one or more servers 120 can be configured to execute web servers and can communicate with the computing devices 110 and/or other devices over the network 105 (e.g., over the Internet).

The service provider platforms 180 can generally correspond to third-party systems, networks, and/or devices that provide service offerings 190 to end-users. The service offerings 190 can generally correspond to any type of product and/or service 190. For example, exemplary service offerings 190 can correspond to ride hailing services, lodging booking services, travel or transportation booking services, ticket-ordering services, parking services, online marketplaces (e.g., which enable end-users to purchase goods and/or services), etc.

In some cases, the service provider platforms 180 can offer service provider applications 160 that enable end-users to access and place orders for the service offerings 180. The service provider applications 160 can be installed on computing devices 110 operated by end-users, and the end-users can utilize the service provider applications 160 to book or place orders for the service offerings 190. For example, in some cases, when an end-user accesses a service provider application 160, the service provider application 160 can present the end-user with various service options 195 related to a service offering 190, and the end-user can select one or more of the service options 195 to place an order for the service offerings 180.

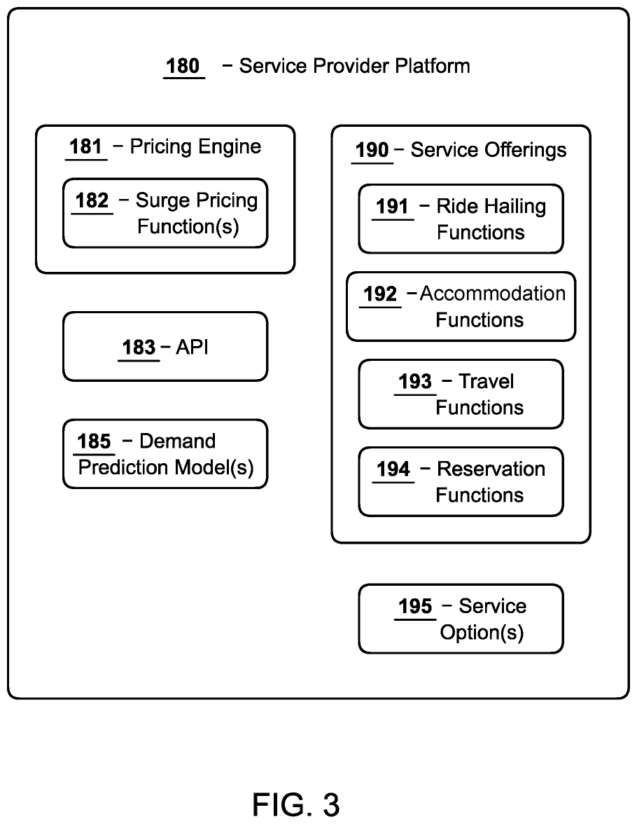

FIG. 3 is a block diagram illustrating features of a service provider platform 180. As mentioned previously, the service provider platform 180 can provide one or more service provider applications 160 that provide end-users with access to service offerings 190 (and corresponding service options 195). In some cases, the service provider applications 160 can be stored on computing devices 110 operating by end-users (e.g., such as a front-end application that communicates with one or more servers hosting the service provider platform 180). Additionally, or alternatively, the service provider applications 160 can be stored and executed by the service provide platform 180 and can be accessed by the computing devices 110 over a network 105 (e.g., can be accessed by a web browser over the Internet or other networks 105).

The service provider platform 180 and/or service provider application 160 can execute various types of functions in connection with providing the service offerings 190 to end-users. Exemplary functions can include: 1) ride hailing functions 191 (e.g., functions that connect end-user passengers with drivers to schedule rides); 2) accommodation functions 192 (e.g., functions that permit end-user guests to schedule rooms or lodging); 3) travel functions 193 (e.g., functions that permit end-user travelers to book or schedule transportation with airlines, trains, buses, boats, cruises, etc.); and 4) reservation functions 194 (e.g., functions that permit end-users to schedule reservations or tickets for restaurants, concerts, events, bars, parking spaces, and/or other venues).

The service provider platform 180 and/or service provider application 160 can execute many other types of functions and provide other types of service offerings 190. For example, in other embodiments, the service provider platform 180 and/or service provider application 160 can execute functions in connection with providing service offerings 190 corresponding to parking services (e.g., affiliated with parking garages, parking lots, parking spaces, etc.), restaurant services, tavern services, entertainment services, ticket scheduling or purchasing services, online marketplaces, etc. The user application 130 also can provide other types of service offerings 190 that are not specifically mentioned in this disclosure.

For example, in scenarios where a service provider platform 180 and/or service provider application 160 executes ride hailing functions 191, the service provider application 160 can present service options 195 that enable a user to customize various parameters for scheduling of a ride or driver. For example, the service options 195 can include scheduling options that permit a user to specify a timeframe for scheduling a pick-up and the prices of each of these options can vary (e.g., such that more urgent rides are priced higher than less urgent rides). The service options 195 also can include vehicle options that enable the user to specify a vehicle type (e.g., a sedan, van, sports utility vehicle, limousine, etc.) and the price of each of these options can vary (e.g., such that certain vehicle types are priced higher than other vehicle types). The service options 195 further can include special request options (e.g., for vehicles with baby seats, bike racks, or other vehicle accessories) and/or vehicle sharing options (e.g., options that indicate whether end-users are willing to share rides with other passengers) and price of these options can vary.

In another example, the service provider platform 180 and/or service provider application 160 can execute accommodation functions 192, and the service provider application 160 can present service options 195 that enable a user to customize various parameters for scheduling a lodging accommodation, such as a room at a hotel and/or short-term home stay (e.g., provided by companies such as AirBnBR). For example, the service options 195 can include scheduling options that permit a user to specify a timeframe or duration for scheduling a room. The service options 195 also can include room type options that enable the user to specify a room type (e.g., having different size beds, amenities, etc.). The service options 195 further can permit a user to specify the number of guests that need to be accommodated, special room options (e.g., options for rooms with certain views and/or rooms that have certain accessories), and/or other options that are related to providing lodging accommodation service offerings.

In other examples, the service provider platform 180 and/or service provider application 160 can provide service options 195 for other types of products or service offerings, such as those corresponding to parking services, restaurant services, tavern services, entertainment services, ticket scheduling service, online marketplaces, etc.

The service provider platform 180 and/or service provider application 160 can execute functions associated with identifying the service options 195 that are presented to end-users, determining prices for the service options 195, and/or fulfilling requests or orders placed for service offerings 190 via the service provider application 160. In certain embodiments, the service provider platform 180 and/or service provider application 160 also can be configured to manage and monitor available inventory (e.g., products and/or services) associated with the service offerings 190, and allocate the inventory to fulfill requests or orders for the service offerings 190 received via the client interface 135. For example, depending on the service offerings 190 provided, the service provider platform 180 and/or service provider application 160 can be configured to manage, monitor and allocate inventory corresponding to drivers, vehicles, rooms, lodging accommodations, parking spaces, restaurant reservations, tickets, goods, etc.

In certain embodiments, the service provider platform 180 includes a pricing engine 181 that is configured to determine pricing for the service offerings 190 and/or service options 195 corresponding to the service options 195. For example, depending on the functionality of the service provider platform 180, the pricing engine 181 can determine pricing for service offerings 190 corresponding to ride hailing services, taxi services, lodging accommodations, event tickets (e.g., for sporting events or concerts), airline tickets, train tickets, parking spaces, etc. Additionally, or alternatively, the pricing engine 181 can determine pricing for specific service options 195 corresponding to the service offerings 190.

In some embodiments, the pricing engine 181 can execute a surge pricing function 182 that is configured to determine and/or adjust prices corresponding to the service offerings 190 or service options 195 based on an available supply and/or demand for the service offerings 190 or service options 195. The surge pricing function 182 can dynamically adjust prices for the service offerings 190 or service options 195 as the supply and/or demand for the service offerings 190 or service options 195 changes over time.

The manner in which the surge pricing function 182 determines or predicts the demand for the service offerings 190 and/or service options 195 can vary. In certain embodiments, the service provider platform 180 includes a demand prediction model 185 that determines or predicts the demand corresponding to the service offerings 190 or service options 195 based, at least in part, by monitoring a level or number of requests or orders placed by end-users via the service provider application 160. The service provider platform 180 also can monitor the locations (e.g., global positioning system or GPS coordinates) of computing devices 110 that have installed the service provider application 160, and determine a number or population of individuals (e.g., end-users) in each of a plurality of geographic regions. This user location or user density information also can be utilized by the demand prediction model 185 to determine or predict the demand for the service offerings 190 or service options 195 in each of the geographic regions. In some embodiments, the demand prediction model 185 can include one or more pre-trained machine learning models that are configured to determine or predict the demand corresponding to the service offerings 190 and/or service options 195.

The manner in which the surge pricing function 182 determines or predicts the supply for the service offerings 190 and/or service options 195 can vary. In some cases, the service provider platform 180 can maintain a database that tracks the supply of available inventory (e.g., drivers, rooms, parking spaces, dining reservations, etc.). This database can be dynamically updated as end-users submit requests for the service offerings 190 and/or as those requests are fulfilled or completed.

The surge pricing function 182 can utilize the supply and/or demand metrics or predictions generated by the service provider platform 180 to dynamically adjust prices corresponding to the service offerings 190 and/or service options 195. When a user accesses the service provider application 160, the service offerings 190 and/or service options 195 can be displayed with prices determined by the surging pricing function 182.

Returning to FIGS. 1A-1B, the application platform 150 can be stored on, and executed by, the one or more servers 120 and the one or more computing devices 110 can enable individuals to access the application platform 150 over the network 105 (e.g., over the Internet via a user application 130 and/or web browser application). Additionally, or alternatively, the application platform 150 can be stored on, and executed by, the one or more computing devices 110. In some cases, the application platform 150 also can be stored as a local application on a computing device 110, or integrated with a local application stored on a computing device 110, to implement the techniques and functions described herein. For example, in some cases, the functionality of the application platform 150 can be integrated with one or more service provider applications 130. The application platform 150 can be executed be stored on, and executed, by other devices as well.

In certain embodiments, the application platform 150 hosts a user application 130 that provides a client interface 135 enabling end-users to interact with a language model 140. The language model 140 can be configured with chatbot functionality and can interact with end-users in connection with fulfilling user requests 171. For example, end-users can submit user requests 171 to the language model 140 and the language model 140 can communicate with the one more of the service provider platforms 180 to generate responses to the user requests 171. The language model 140 includes a communication framework 170 that enables the language model 140 to communicate with the service provider platforms 180 to generate outputs responsive to the user requests 171.

End-users can submit various types of user requests 171. In some scenarios, the user requests 171 can include inputs that request information or data from one or more service platform providers 180 (and, in many cases, simultaneously from multiple service platform providers 180). Amongst other things, end-users can submit user requests 171 to the language model 140 to obtain information related to service offerings 190 (and/or corresponding service options 195) provided by the service provider platforms 180. The end-users also can submit user requests 171 to the language model 140 to schedule or place orders for the service offerings 190 and/or corresponding service options 195 provided by the service provider platforms 180. The end-users can submit many other types of user requests 171 as well.

Additionally, the language model 140 can store and execute a preemptive analysis function 173 that enables the language model 140 to preemptively or proactively initiate interactions with end-users. For example, this preemptive analysis function 173 can be configured to present end-users with one or more service options 195 in scenarios when the language model 140 predicts or determines such service options may be desired by the end-users. Additional details relating to this preemptive functionality are provided in further detail below.

In some cases, the user application 130 can include a front-end that is stored on computing devices 110 (e.g., smart phone or mobile devices) operated by end-users, and a back-end that is executed by one or more servers 120. The front-end of the user application 130 can include a client interface 135 that enables end-users operating the computing devices 110 to interact with the application platform 150, such as to submit user requests 171 corresponding to the service offerings 190 offered by the service provider platforms 180. The client interface 135 can include one or more graphical user interfaces (GUIs) that include interactive options (e.g., buttons, menus, text prompts, etc.) that enable end-users to submit the requests and/or place orders for the service options 190.

The client interface 135 also can enable an end-user to communicate with the language model 140 (e.g., in some cases, in connection with the service offerings 190 offered by the service provider platforms 180). When user requests 171 are received via client interface 135, the language model 140 can utilize the communication framework 170 to communicate with the service provider platforms 180 and the language model 140 can generate responses to the user requests 171 based on information received from the service provider platforms 180 (e.g., responses related to the service offerings 190 and/or service options 195 provided by the service provider platforms 180). The responses generated by the language model 140 can be output via the client interface 135 and, in some cases, the end-user may interact with client interface 135 to select or place an order for a desired service option 190.

As explained in further detail below, the language model 140 can be configured to communicate with a plurality of service provider platforms 180 to generate multi-platform responses 172 in response to user requests 171. Generally speaking, a multi-platform response 172 can represent a response that is generated based, at least in part, on communications with two or more service provider platforms 180. Examples of multi-platform responses 172 can include responses that present service options 195 obtained from multiple service provider platforms 180 and/or responses that are derived from an evaluation of service options 195 from multiple service provider platforms 180.

In one example, a user request 171 may include a request for a cheapest service option 195 currently available for a ride. In this scenario, the language model 140 can communicate with multiple service provider platforms 180 that provide ride hailing services (e.g., Uber®, Lyft®, etc.) to obtain available ride service options, and the language model 140 can generate a multi-platform response 172 that identifies the cheapest ride option.

In another example, a user request 171 can request pricing information for a particular product or item. In this scenario, the language model 140 can communicate with multiple service provider platforms 180 that provide online marketplaces (e.g., Amazon®, Walmart®, Alibaba®, etc.) to obtain available service options, and the language model 140 can generate a multi-platform response 172 that provides a summary of the options offered by each marketplace provider, as well as corresponding pricing information for the options. Alternatively, the multi-platform response 172 can include a single option that is identified by the language model 140 as being most optimal for the end-user (e.g., based on user preferences 148, previous activity patterns of the end-user, etc.). In some cases, the multi-platform response 172 can include a response that automatically places an order for the option determined to be most optimal, thereby eliminating human decision making from the process entirely,

In another example, the preemptive analysis function 173 executed by the language model 140 can predict that an end-user currently needs parking garage services (or will need parking services in the near future). In this scenario, the language model 140 and/or preemptive analysis function 173 can proactively communicate with multiple service provider platforms 180 that provide parking services (e.g., ParkWhiz®, SpotHero®, ParkMe®, etc.) to obtain available parking service options, and the language model 140 can preemptively output a multi-platform response 172 via the client interface 135 that identifies one or more parking service options.

Staying with the above example, in some instances, the multi-platform response 172 can include a single parking service option that is determined or predicted to be most optimal for the end-user based on the user-preferences 148 and/or user activity patterns learned by the language model 140. In one example, the language model 140 may understand that the end-user frequently visits a particular location and is willing to pay extra for the closest parking service option. Therefore, multi-platform response 172 generated by the language model 140 can identify a single parking service option corresponding to a parking garage located nearest to the location (even if it is more expensive than other options in the area), and this single option can be sent the end-user for confirmation and/or can be utilized to automatically place an order for the parking service option. In another example, the language model 140 may understand that the end-user is extremely price sensitive and, therefore, may select a single parking service option that is significantly cheaper than other parking service options located in the area. Providing a single, optimally selected service option in this manner can obviate the need for the end-user to make a selection among multiple service options, and can improve the end-users experience by significantly reducing the time spent scheduling the service options.

As demonstrated herein, the types of multi-platform responses 172 can vary greatly. Some examples discussed herein involve multi-platform responses 172 that relate to service options 195 provided by service provider platforms 180. However, other types of the multi-platform responses 172 also can be generated that do not necessarily involve service options 195.

For example, in other instances, a user request 171 can include a request for hotels that are located in a particular geographic area. In this scenario, the language model 140 can communicate with multiple service provider platforms 180 that provide hotel booking services (e.g., Expedia®, Orbitz®, Priceline®, etc.) to obtain available hotel location information, and the language model 140 can generate a multi-platform response 172 that provides a listing of the hotels in the area (and may display corresponding hotel locations on a map).

As explained in further detail below, the language model 140 can be trained to interact with end-users in connection with obtaining information from service provider platforms 180 and/or placing orders for service offerings 190 or corresponding service options 195. The language model 140 can be trained to understand and generate human language. For example, the language model 140 can operate as chatbot that is configured to interpret questions and/or statements input via the client interface 135, and generate answers and/or responses that are output or displayed via the client interface 135.

In certain embodiments, the user application 130 can communicate with the language model 140 via an application programming interface (API) 142. For example, in some cases, the language model 140 can be developed or provided by a third-party (e.g., such as the ChatGPT service offered by OpenAIR) and the user application 130 can transmit inputs (e.g., voice and/or text-based inputs) corresponding to user requests 171 to the API 142, and can receive responses from the language model 140 via the API 142. Additionally, or alternatively, the language model 140 can be integrated directly into the user application 130 and/or can be hosted by the application platform 150.

Various types of language models 140 can be utilized by the user application 130. In some embodiments, the language model 140 can include a generative pre-trained transformer (GPT) model 141 (e.g., a GPT-1, GPT-2, GPT-3, or subsequently developed GPT model). Additionally, or alternatively, the language model 140 can include a BERT (Bidirectional Encoder Representations from Transformers) model, an XLNet model, a RoBERTa (Robustly Optimized BERT pre-training approach) model, and/or a T5 (Text-to-Text Transfer Transformer) model. These or other types of machine learning or AI language models can be used to implement the language model 140. Additionally, it should be recognized that, in some embodiments, the language model 140 can represent a single model and, in other embodiments, the language model 140 can be comprised of multiple learning models (including any combination of the aforementioned models) that cooperate together.

In some cases, the user requests 171 submitted by the end-user via the client interface 135 can include text inputs and/or voice inputs. For example, a user may provide text inputs via a touch screen, physical keyboard, digital keyboard, or by other means. Additionally, a user can provide voice inputs (or audio-based inputs) via a microphone included on a computing device 110 that is operated by the user. In some embodiments, speech recognition software can be executed to convert the voice inputs to text inputs, which can then be provided to the language model 140. When a user interacts with language model 140, the input initially can be tokenized into a sequence of words (or sub-words), which are then processed by the language model 140 to generate a response.

In certain embodiments, the language model 140 can include a transformer neural network architecture 143 that includes a self-attention mechanism, which allows the model to weigh the importance of different parts of the input when generating its output or response. The self-attention mechanism allows the model to selectively focus on different parts of the input when generating its output or response, rather than relying on a fixed context window like other language models. Additionally, the transformer neural network architecture 143 can include a series of layers, each of which applies self-attention and other types of neural network operations on a given input that is received. The layers can be arranged in a stacked configuration, such that the output of one layer is fed as input to the next layer, thereby allowing the model to gradually refine its representation of the input as it is processed through the layers.

Various types of training procedures 144 can be utilized to train the language model 140. In some cases, one or more supervised or semi-supervised training procedures 144 can be utilized to train the language model 140. Additionally, or alternatively, one or more unsupervised training procedures 144 can be utilized to train the language model 140.

In some embodiments, the language model 140 is trained via a self-supervised training procedure 144 that includes both an unsupervised training phase and a supervised training phase. The unsupervised training phase can include a pre-training step in which the learning model 140 is trained on a large corpus of text to learn patterns and relationships between words, phrases, sentences, and/or other human language elements. The supervised training phase can be used for fine-tuning and can train the language model 140 using one or more labeled datasets to facilitate learning of specific natural language processing (NLP) tasks, such as language translation, language generation, question answering, text classification, text summarization, etc. In certain embodiments, the training datasets 146 can be derived from a text corpus accumulated from multiple sources, such as web pages, books, academic articles, news articles, and/or other text-based works.

In some embodiments, the training datasets 146 can be customized or supplemented with domain-specific textual content relating to service offerings 190 and/or service options 195 offered via the service provider applications 160 and/or service provider platforms 180, and a transfer learning procedure 145 can be executed to fine-tune the training of the language model 140 on the domain-specific textual content. For example, the training dataset 146 can be supplemented with text relating to customizing options for providing the service offerings 190 and/or service options 195 to end-users. The training dataset 146 also can be supplemented with text corresponding to historical user interactions with the service offerings 190 and/or service options 195. Using this domain-specific content to supplement the training of the language model 140 can significantly improve communications between the language model and end-users, as well as communications between the language model 140 and the service provider platforms 180.

In one example, a service provider application 160 can execute ride hailing functions 191 in connection with offering ride hailing services, and the training dataset 146 can be supplemented with textual content that enables the learning model 140 to understand service options 195 relating to: scheduling options and rates (e.g., options to receive a driver more rapidly in exchange for paying a higher rate or options to receive a driver less rapidly in exchange for paying a lower rate); vehicle options (e.g., a sedan, van, or sports utility vehicle); special request options (e.g., for vehicles with baby seats, bike racks, or other vehicle accessories); vehicle sharing options (e.g., options that enable end-users to share rides with other passengers); and/or other options that are related to providing ride hailing services.

In another example, a service provider application 160 can execute accommodation functions 192 in connection with offering lodging accommodation services, such hotel booking services and/or short-term home stay services. In this example, the training dataset 146 can be supplemented with textual content that enables the learning model 140 to understand service options 195 relating to: room type options and rates (e.g., options to receive a higher quality room in exchange for a higher rate or options to receive a lower quality room in exchange for a lower rate); number of guest options (e.g., options that enable end-users to specify the number of guests needed that need to be accommodated); special room options (e.g., options for rooms with certain views and/or rooms that have certain accessories); and/or other options that are related to providing lodging accommodation services.

In other examples, service provider applications 160 can provide service offerings 190 (e.g., products and/or services) in other business verticals. The products and/or services can be affiliated with other any business vertical, such as transportation services (e.g., ticket bookings for buses, trains, airplanes, cruises, boats, etc.), parking services (e.g., affiliated with booking spaces in parking garages, parking lots, etc.), restaurant services, tavern services, entertainment services, etc. The language model 140 can be trained with a customized, domain-specific dataset that is specific to these and other services offerings.

In some cases, the aforementioned self-supervised training procedure can initially be applied to train the language model 140. Thereafter, a transfer learning training procedure 145 can be applied to fine-tune the training of the language model 140 (or an associated sub-model) using one or more domain-specific datasets.

In certain embodiments, an end-user can interact with the language model 140 to obtain information pertaining to available service offerings 190 (and corresponding service options 195) provided by multiple service provider platforms 180, place an order or schedule a service offering 195 (based on corresponding service options 195), and/or perform other related functions. The language model 140 can be configured to interpret user requests 171 (e.g., which may include questions, statements, commands, etc.) received from the end-user via the client interface 135, communicate with the service provider platforms 180 to obtain information related the user requests 171, and generate responses based on the information obtained from the service provider platforms 180, which can be provided to the end-user via the user interface 135.

The language model 140 can communicate with the service provider platforms 180 in various scenarios. For example, in response to receiving a user request 171 from an end-user requesting available service options 195 for a service offering 190, the language model 140 can communicate with a plurality of service provider platforms 180 to obtain information about available service options 195 (including pricing information corresponding to the service options 195). Likewise, in response to receiving a request to schedule or place an order for a service offering 190, the language model 140 can communicate the one or more service provider platforms 180 to initiate scheduling or placement of the order. The language model 140 can communicate with the service provider platforms 180 in many other contexts as well.

The language model 140 can include or utilize a communication framework 170 to communicate with each of the service provider platforms 180. The communication techniques utilized by the communication framework 170 can vary. In certain embodiments, the communication framework 170 can enable the language model 140 to communicate with the service provider platforms 180 via an API provided by each of the service provider platforms 180 (e.g., such API 183 in FIG. 3). In some cases, the language model 140 may communicate simultaneously and/or in parallel with multiple service provider platforms 180 to obtain information for generating the multi-platform responses 172 and/or other outputs.

These aforementioned communication techniques provide several technological improvements. Amongst other things, these techniques overcome and/or circumvent technical hurdles associated with locally accessing or sharing data among applications installed on computing devices 110 operated by the end-users (which, in many cases, may be prohibited). Additionally, by communicating with multiple service platforms 180 simultaneously or in parallel, this can reduce the processing time of the language model 140 with respect to generating the multi-platform responses 172 and/or other outputs that rely on information from multiple sources. With respect to the latter, this can be particularly advantageous to reduce processing times in scenarios where the multi-platform responses 172 are derived from large numbers of service platform providers 180 (e.g., dozens or even hundreds of providers).

Additionally, or alternatively, the communication framework 170 can be provided with permissions to access and utilize service provider applications 160 installed on computing devices 110 operated by end-users to communicate with the service provider platforms 180. For example, when a user application 130 is installed on a computing device 110 of an end-user, the user application 130 may request that the end-user authorize permissions to access and utilize the service provider applications 160 installed on the computing device 110. After permissions are granted, the communication framework 170 can communicate with the service provider platforms 180 via the service provider applications 160.

Other types of communication techniques also can be utilized to enable the language model 140 to communicate with the service provider platforms 180.

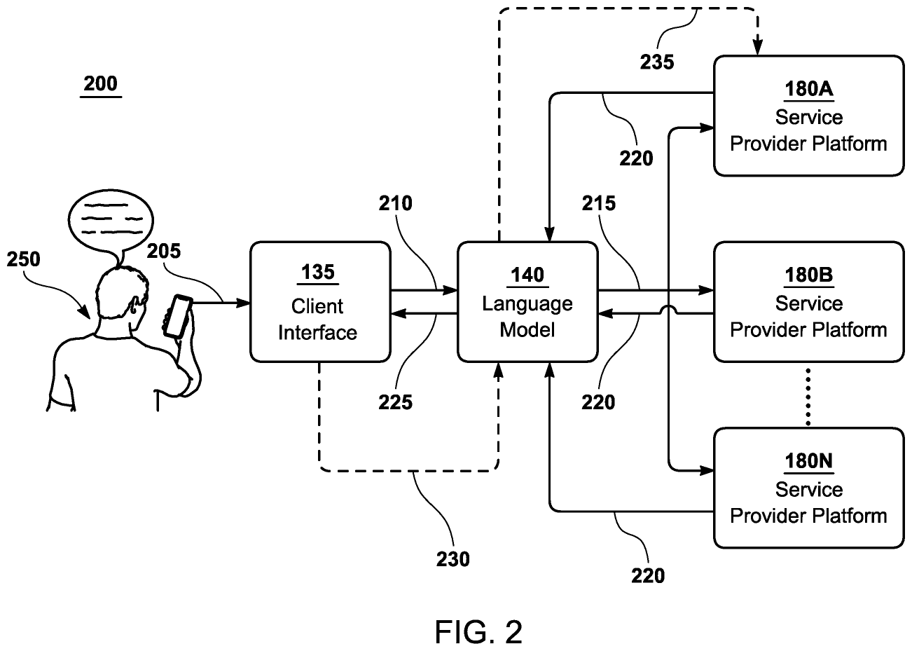

FIG. 2 is block diagram that illustrates an exemplary process flow 200 demonstrating how the language model 140 can operate as an intermediary to facilitate scheduling or ordering of service offerings 190 provided by service provider platforms 180 according to certain embodiments. The description of FIG. 2 includes an example of how the process flow 200 can be applied in connection with providing service offerings 190 corresponding to ride hailing services. However, it should be recognized that the process flow 200 can be applied to many other types of service offerings 190 (e.g., lodging bookings, reservation scheduling, ticket purchases, online marketplaces, etc.).

At step 205, an end-user 250 submits a user request 171 to a client interface 135, which can be provided via a front-end of a user application 130. The user request 171 can be a text input and/or a voice or audio input. The content of the user request 171 can vary. In some cases, the user request 171 can include a request pertaining to a service offering 190 (or related service options 195) provided by a plurality of different service provider platforms 180, such as service provider platforms 180A, 18B, . . . 180N (where N can represent any positive integer). Each of the service provider platforms 180 can be affiliated with a separate or distinct third-party entity (e.g., company, organization, etc.). The user request 171 may include content specifying user preferences corresponding to the service options 195.

In one example, the user request 171 requests information relating to scheduling a ride via a ride hailing service, which is a service offering that can be provided by a multitude of third-party service providers platforms 180 (e.g., such as Uber®, Lyft®, InDrive®, etc.). For example, the input can include a query requesting availability of a particular vehicle type (e.g., a SUV) within the next ten minutes for the cheapest price available.

At step 210, the user request 171 received via the client interface 135 is provided to language model 140. In some cases, the input may be provided via an API 142 of the language model 140 (e.g., transmitted over a network 105 to a server 120 that hosts the language model 140). Additionally, or alternatively, the language model 140 can be integrated directly with the client interface 135, a front-end of the user application 130, and/or a back-end of the user application 130. Upon receiving the input, the language model 140 can analyze the input to interpret its meaning and/or to understand the intentions of the end-user 250.

Staying with the above example, the language model 140 can analyze the user request 171 for scheduling a ride. This analysis can enable the language model 140 to identify the type of service offering 190 being requested (e.g., ride hailing services) and service provider platforms 180 that provide the service offering 190. The language model 140 can further discern the service options 175 requested by the user (i.e., specifying a SUV vehicle type, pickup time in less than 10 minutes, and the lowest price offered by one of the service provider platforms 180).

At step 215, the language model 140 initiates a communication exchange with a plurality of service provider platforms 180A-180N. In some cases, the communication exchange can involve the language model 140 transmitting a request for available service options 195 pertaining to the service offering 190 to each of the service provider platforms 180A-180N. Each of these requests can be a user-specific request that is generated and customized based on the parameters specified in user request 171 received from the end-user 250. As explained in further detail below, the language model 140 also can customize the request based on a pricing threshold 149 and/or other user preferences 148 that are learned by the language model 140 (e.g., through continuous interactions with the end-user 250).

Staying with the above example, in response to receiving the user request 171 from the end-user 250, the language model 140 can extract the user-specified criteria (e.g., SUV car type, pick-up within next ten minutes, etc.), and utilize this criteria to generate and transmit custom requests to each of the service provider platforms 180A-180N to determine if there are available service options 190 matching the user-specified criteria.

The service provider platforms 180A-180N are configured to monitor and manage an inventory pertaining to the service offering 190 (e.g., available drivers or vehicles), and to determine pricing for the service options 195 corresponding to the service offering 190. Upon receiving a user-specific request from the language model 140, each of the service provider platforms 180 can perform an analysis to determine if there are available service options 190 that match the request.

At step 220, each of the service provider platforms 180 can generate a listing of the available service options 190 (including pricing for each service option 190) and transmit the listing to the language model 140 in response to determining that one or more service options 190 match the request. Alternatively, if a service provider platform 180 determines that no service options 190 match the request, the service provider platform 180 can transmit a message to the language model 140 indicating that there are no available service options 195 corresponding to the request. In some embodiments, in the event that no service options 195 match the request for one or more of the service provider platforms 180, the language model 140 can communicate with the each of these service provider platforms 180 to determine alternative service options 195, which can be transmitted to the language model 140.

Staying with the above example, if service options 195 are available that match the end-user's request, each of the ride hailing service providers can generate a listing of different ride options (e.g., a first option that provides a SUV within the next five minutes for ten dollars, a second option that provides a SUV within the next eight minutes for nine dollars, etc.). Alternatively, if no ride options match the user request for a given ride hailing service provider, the language model 140 can communicate with the ride hailing service provider to determine an alternative listing of ride options (e.g., a first option that provides a sedan within the next five minutes for ten dollars, a second option that provides a SUV within the next ten minutes for thirty dollars, etc.).

At step 225, the language model 140 analyzes the feedback provided by each of the service provider platforms 180A-180N and generates a multi-platform response 172 based on to the user request 171, which can be output via the client interface 135 for presentation to the end-user 250. In some cases, the language model 140 generates a human language response corresponding to the user request 171 that identifies one or more services options 195, and the human language response is output via the client interface 135. In some cases, the multi-platform response 172 can include a summary of various service options 195. In other cases, the multi-platform response 172 can identify a single service option 195 that is determined to be optimal for the end-user 250.

In some cases, the multi-platform response 172 generated by the language model 140 can include interactive options (e.g., buttons) that enable the end-user 250 to select and/or decline the one or more service options 195. The end-user 250 also can select and/or decline the service options 195 by providing a human language response to the language model 140.

Staying with the above example, the language model 140 can analyze the responses from the ride hailing service providers to generate a multi-platform response 172 for output via the client interface 135. For example, in the event that multiple service options 195 are available that include a SUV with a pickup time of less than ten minutes, the language model 140 can identify the option having the lowest price and output the option via the client interface 135. The service option 195 can be displayed with related information (e.g., identifying the company associated with the service option, the price of the service option, etc.) and the end-user can select an interactive option or provide a human language response to accept or decline the option. In some cases, the end-user 250 can be presented with multiple service options 195 (e.g., the three cheapest options for a SUV in within the next ten minutes).

In the event that the end-user 250 is not interested in any of the service options 195 presented, the end-user 250 can submit a second input to the language model 140 to request alternative service options 195. In this scenario, the process may repeat steps 205 through 225 to determine alternative service options 195. For example, if the end-user does not like any service options 195 related to scheduling a ride (e.g., because the cheapest priced options are still too expensive), the end-user can submit a second input revising the initial criteria (e.g., a second request for a SUV within the next twenty-five minutes with the cheapest price).

At step 230, the end-user 250 can optionally select one of the service options 195 presented via the client interface 135 and the selection can be transmitted to the specific service provider platform that provided the selected service option 195 at step 235 (in this example, service provider platform 180A). In some cases, the selection made by the end-user 250 can be transmitted to the language model 140, which can relay the selection to the to the service provider platform. Alternatively, the selection can be transmitted directly from the client interface 135 to the to the service provider platform. Upon receiving the selection, the service provider platform can execute functions for providing the service offering 190 based on the selected service option 195 to the end-user 250.

Staying with the above example, if the end-user 250 selects a ride option offered by a ride hailing service provider, the selection can be relayed to the corresponding ride hailing provider platform that provided the ride option. In response to receiving the selection, the ride hailing provider platform can execute ride hailing functions 191 to schedule a ride for the end-user 250 based on the selected ride option.

The above example involved a user request 171 related to obtaining service options 195 for a plurality of service provider platforms 180A-N. However, it should be recognized that the process flow 200 also can be applied to respond to user requests 171 that are not related to obtaining information pertaining to service options 195 or placing an order for service options 195. For example, a user request 171 may be received that asks how many parking garages are located within a mile of an end-user's location, or which requests locations of Italian restaurants in a particular geographic region. In each of these scenarios, the language model 140 may communicate with a plurality of service provider platforms to generate a multi-platform response 172 that is responsive to the user request 171.

Returning to FIGS. 1A-1B, the language model 140 can include a continuous learning (or incremental) learning framework 147 that enables the language model 140 to continuously learn over time based on interactions with end-users operating the computing devices 110. For example, in some embodiments, the continuous learning framework 147 can enable the language model 140 to improve responses output to end-users via the client interface 135 and/or improve communications with the service provider platforms 180 (e.g., for determining and presenting service options 195 to end-users).

In some cases, the continuous learning framework 147 can enable the language model 140 to learn on a global basis based on aggregated interactions with all of the end-users. For example, aggregated interactions across the end-users can be utilized to improve interactions with the end-users and/or to improve the ability of the language model 140 to interact with the service provider platforms 180.

Additionally, the continuous learning framework 147 also can enable the language model 140 to recall historical interactions with specific end-users, and utilize the historical interactions to customize service options 195 presented to the end-users. For example, in certain embodiments, the continuous learning framework 147 can enable the language model 140 to learn user preferences 148 for service options 195 and/or service offerings 190 for each end-user based on historical interactions with each of the end-users. The language model 140 can then customize service options 195 to the end-user based on the user preferences 148.

In some scenarios, the ability of the continuous learning framework 147 to learn granular, personalized user preferences 148 for an end-user can enable the learning model to generate multi-platform responses 172 that identify a single service option determined or predicted to be the most optimal for the end-user. For example, using the knowledge of the user preferences 148, the language model 140 may analyze available service options provided by multiple service provider platforms 180 and generate a multi-platform response 172 identifying or predicting a single service option that is optimal for the end-user. As mentioned above, this can be beneficial to avoid inconveniencing the end-user with having to analyze and compare various service options from multiple service providers.

In some cases, the historical interactions with the end-users can enable the language model 140 to learn or predict pricing thresholds 149 for each of the end-users. The pricing threshold 149 for an end-user may correspond to a maximum price and/or pricing rate that an end-user is willing to pay for a service offering 190 provided via the end-user application 130.

In certain scenarios, the pricing engines 181 and/or surge pricing functions 182 executed by the service provider platforms 180 can apply different multipliers (e.g., 1×, 1.5×, 2×, 2.5×, 3×, etc.) to prices for service options 195 based on a demand for a service offering 190 (e.g., such that the multiplier serves to increase the price of the service options 195 when demand for the service offering 190 is high). The pricing engines 181 and/or surge pricing functions 182 also may apply a multiplier to the prices of service options 195 in other scenarios (e.g., such as when an end-user is willing to pay more in response to receiving a service offering 190 more rapidly). In these scenarios, the pricing threshold 149 learned by the language model 140 can correspond to a maximum pricing multiplier that an end-user is willing to pay for a service option 195.

The language model 140 can utilize the pricing threshold 149 for a given end-user to customize or personalize the service options 195 presented to the end-user. For example, a first end-user that routinely selects service options 190 with higher prices may be presented with higher-priced service options 190, while a second end-user that routinely selects the cheapest service option 190 can be presented with lower-priced service options.

In one example, end-users may submit user requests 171 for ride sharing services and the continuous learning framework 147 can enable the language model 140 to learn user preferences 148 for service options 195 corresponding to ride requests (e.g., such as preferences for particular vehicle types, preferences indicating whether the end-user is willing to pay more for quicker service, preferences for baby seats or other accessories, etc.). The continuous learning framework 147 also can enable the language model 140 to learn a pricing threshold 149 for the end-user (e.g., indicating the maximum price or multiplier the end-user is willing to pay for a ride). When the end-user interacts with the language model 140 to request a driver or ride, the language model 140 can communicate with the service provider platforms 180 to identify service options 195 that match the end-user's pricing threshold 149 and/or other user preferences 148.

In certain embodiments, the continuous learning framework 147 also can be configured to detect or determine end-user activity patterns that can be utilized to identify or predict scenarios in which the end-users will need or desire service offerings 190. These detected activity patterns can trigger the language model 140 and/or preemptive analysis function 173 to preemptively or proactively interact with end-users (e.g., to transmit multi-platform responses 172 to end-users that include one or more service options pertaining to the service offerings 190).

The types of activity patterns learned by the continuous learning framework 147 can vary greatly. In one example, an activity pattern may indicate that an end-user routinely desires and/or places an order for a particular service offering 190 (ride hailing service offering) when the end-user is located in a particular geographic area (e.g., at a particular longitude/latitude and/or at a particular residence or business establishment). When the end-user is located in that area at some point in the future, the preemptive analysis function 173 can be triggered to interact with one or more service provider platforms 180 and present the end-user with one or more service options 195 (e.g., ride hailing service options).

In another example, an activity pattern may indicate that an end-user routinely desires and/or places an order for a particular service offering 190 (food ordering and delivery offering) at a particular time each weekday (e.g., lunchtime). In this example, when the time arrives on a weekday, the preemptive analysis function 173 can be triggered and executed to interact with one or more service provider platforms 180 and present the end-user with one or more service options 195 (e.g., food ordering service options).

Many other types of activity patterns also can be learned by the continuous learning framework 147. The end-user activity data that enables the continuous learning framework 147 to detect these activity patterns can be obtained from various sources. For example, in some cases, the end-user activity data can be obtained from a database that stores previous interactions between end-users and the language model 140. Additionally, or alternatively, the end-user activity data can be obtained from interactions between the end-users and service provider applications 160 (or service provider platforms 180), and this data may be accessed may be accessed by the communication framework 170 described herein.

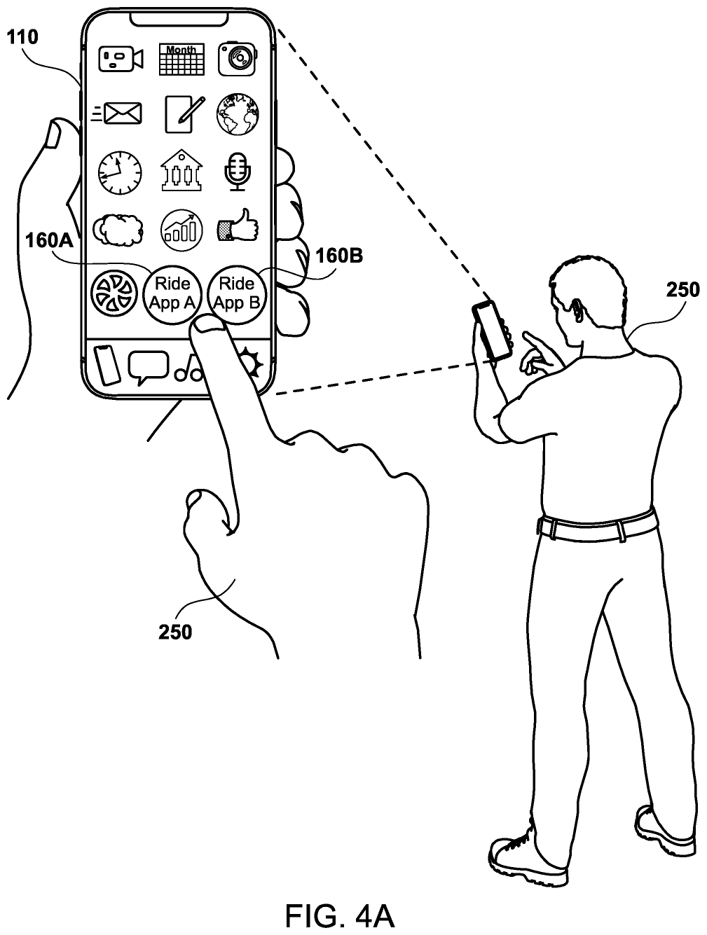

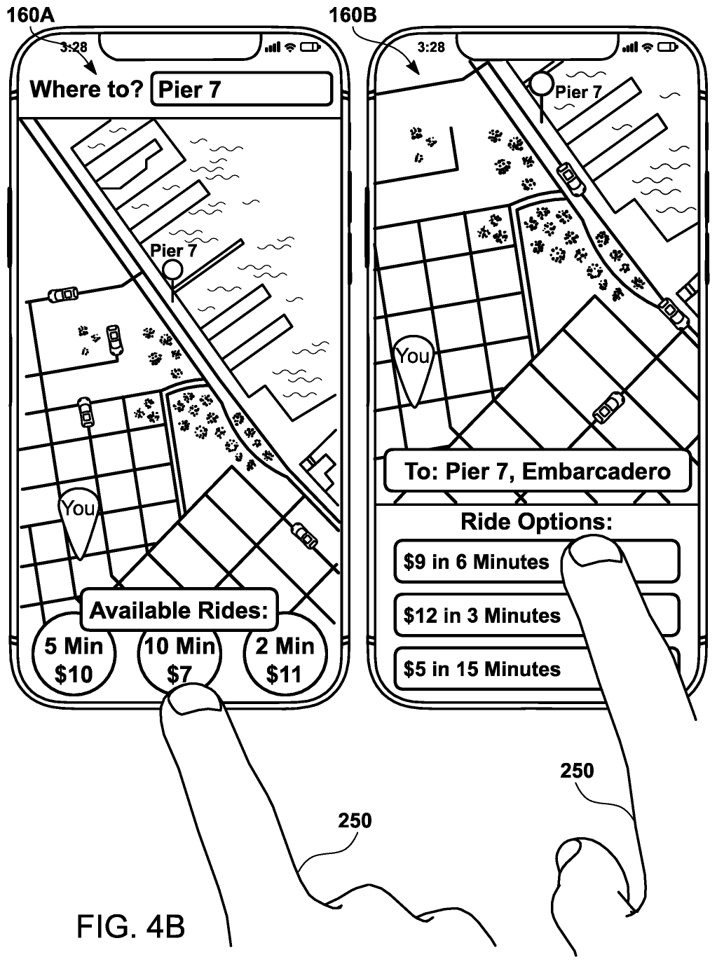

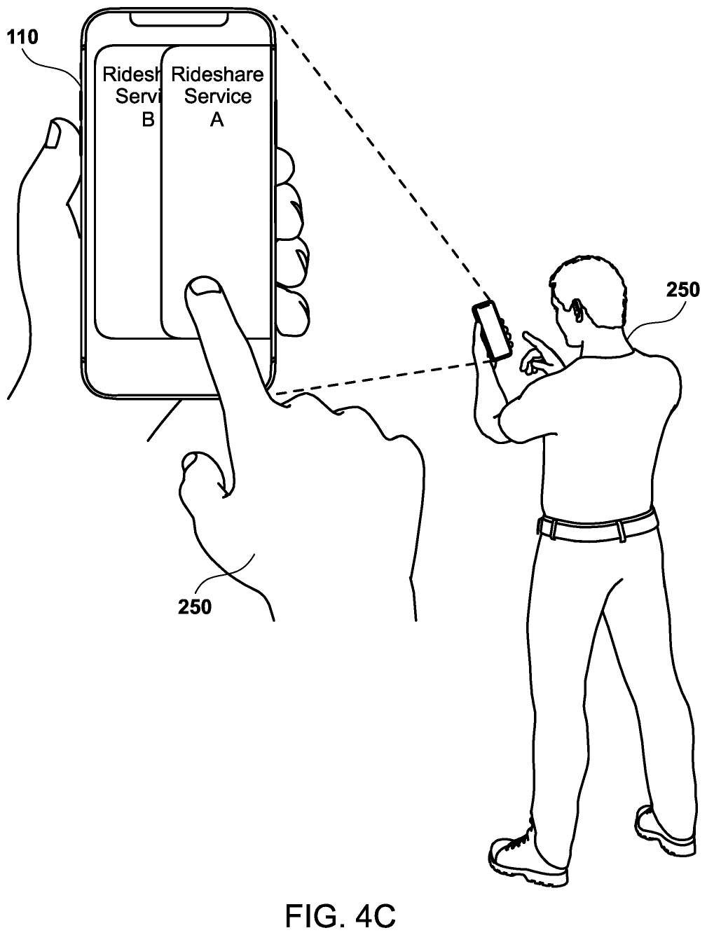

FIGS. 4A-4C illustrate common use cases that can frustrate end-user experiences with scheduling or placing an order for a service offering 190. While these figures illustrate an exemplary service offering 190 for ride sharing services, it should be understand that the same problems can exist for many other types of service offerings 190.

In the example of FIGS. 4A-4C, an end-user is seeking to schedule a ride or driver using a computing device 110 (e.g., a smart phone) and wishes to understand the service options 195 that are available. As illustrated in FIG. 4A, multiple service provider applications 160 (e.g., such as a service provider applications 160A and 160B) are installed on the computing device 110. In this example, two service provider applications 160A and 160B are illustrated. However, greater numbers of service provider applications 160 can be installed on the end-user's computing device 110 in other scenarios. Each of the service provider applications 160 are provided by a separate service provider platform 180 (e.g., a separate entity or company).

As illustrated in FIG. 4B, the end-user separately opens each of the service provider applications 160 to understand the service options 195 that are available via each service provider platform 180. The end-user is required to repetitively enter the parameters for the ride (e.g., destination, pickup time, vehicle type, etc.) into each of the service provider applications 160. Each of service provider applications 160 may offer different service options 195 for scheduling the ride (e.g., different prices, vehicle types, etc.).

As illustrated in FIG. 4C, the end-user 250 is scrolling or swamping between the various service provider applications 160 to manually compare the service options 195 offered by each. As the end-user 250 is comparing the service options 195 provided by each of the service provider applications 160, the service options 195 are subject to changes. For example, when the end-user 250 initially viewed the service options 195 provided by a first service provider application 160A, the prices, pickup times, and/or other options can change as the end-user viewed the service options 195 provided by a second service provider application 160B.

The overall experience of manually entering service option parameters into each service provider application 160, manually comparing the service options 195 of each service provider application 160, and attempting to avoid changes in service options 195 can frustrate the end-user experience. In many cases, this frustration can result in an end-user not placing an order for a service offering 190 with any of the service provider applications 160.

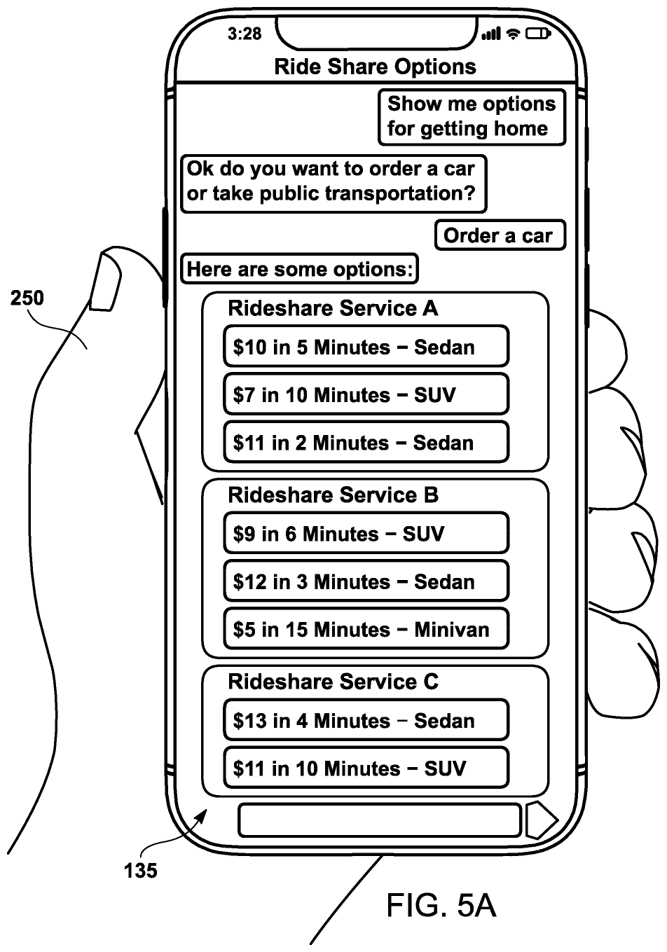

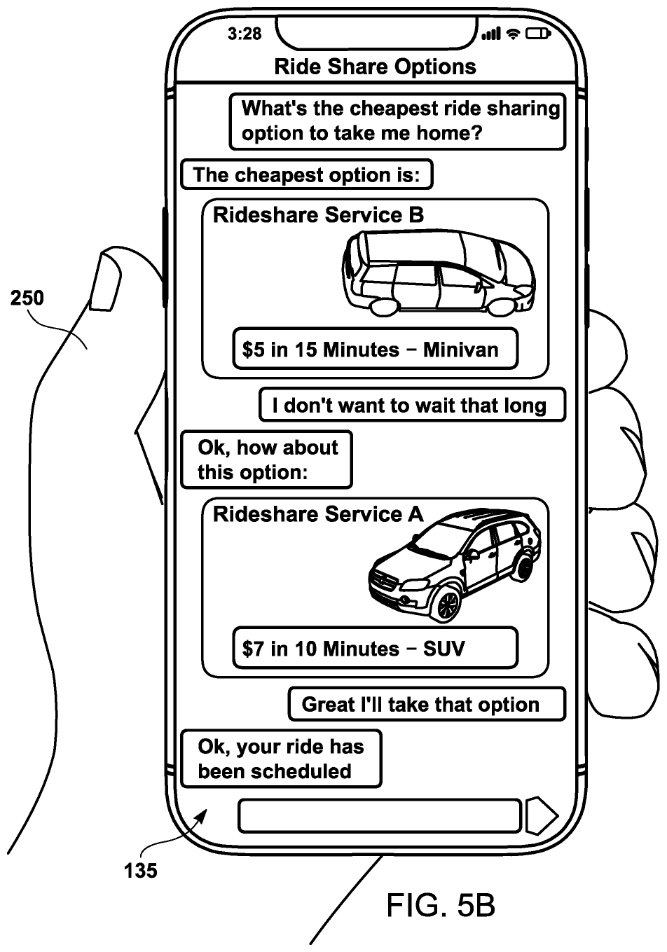

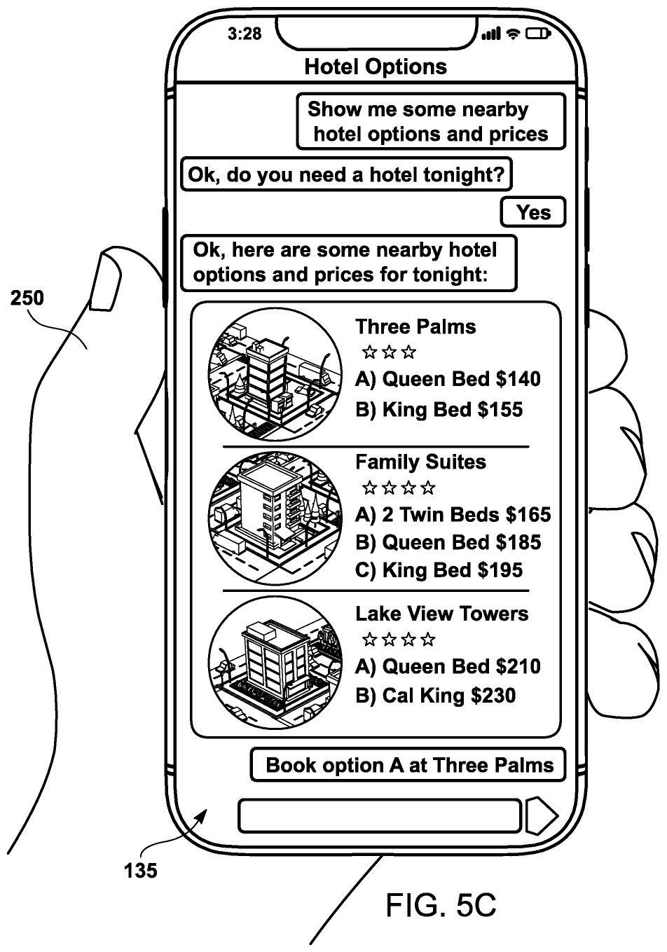

FIGS. 5A-5C illustrate how the language model 140 can operate as an intermediary between an end-user and multiple service provider platforms 180 to improve end-user experiences with scheduling or placing an order for service offerings 190 according to certain embodiments. While these figures illustrate exemplary service offerings 190 for ride sharing services and lodging accommodations, it should be understand that the benefits can be provided for any other types of service offering 190.

As illustrated in FIG. 5A, an end-user 250 submits a user request 171 for transportation options via a client interface 135. The user requests 171 is analyzed and processed by the language model 140 to discern the intent of the user requests 171 and to identify relevant service provider platforms 180. The language model 140 generates a response to better understand the intent of the user request 171, and requests whether the end-user would like to obtain options for public transportation or ride hailing services. The end-user provides a second input clarifying the intent of the initial user request 171 is for ride hailing services. The language model 140 utilizes the communication framework 170 to communicate with a plurality of service provider platforms 180 that provide service offerings 190 for ride hailing services. The language model 140 generates a multi-platform response 172 based on an analysis of the feedback received from the plurality of service provider platforms 180. The multi-platform response 172 is displayed via the client interface 135 to the end-user 250, and includes a plurality of service options 195 offered by different ride hailing service providers. The output also includes interactive options that enable the end-user 250 to select, and place an order for, a desired service option 195 offered by one of the ride hailing service providers.

In certain embodiments, the service options 195 presented to the user can be customized based on user preferences 148 (e.g., pricing threshold 149, vehicle type preference, etc.) learned by the language model 140 via its continuous learning framework 147. In this example, the language model 140 requested clarification regarding the type of transportation desired (e.g., public transportation vs ride hailing services). In future interactions with the language model 140, the language model 140 may understand that the end-user 250 is requesting ride hailing options based on previous interaction patterns and/or inputs provided by the end-user 250.

This example illustrates several improvements to the end-user experience. The end-user was not required to separately open multiple service provider applications 160, enter ride parameters multiple times in each service provider application 160, nor manually compare service options 195. Instead, a single exchange between the end-user and the language model 140 enabled service options 195 to be obtained from multiple service provider platforms 180, and the service options 195 were presented via the client interface 135 in a compact user-friendly manner. Additionally, the service options 195 presented can be automatically customized based on user preferences 148 learned by the language model 140. Even further, because the end-user was not required to scroll or swap among multiple service provider applications 160, this eliminates (or at least reduces) the chance that certain service options 195 become unavailable while the end-user evaluates the service options 195.

FIG. 5B shows another example in which an end-user 250 interacts with the language model 140 to obtain information relating to ride hailing services (e.g., which can include ride sharing services). In this example, the end-user 250 submits a user request 171 for the cheapest ride hailing option available to take the end-user home. In response to receiving the user request 171, the language model 140 analyzes and discerns the intent of the use request 171. The language model 140 then generates and transmits a user-specific request (e.g., identifying a destination address for the end-user's home) to each of a plurality service provider platforms 180, and each of the service provider platforms 180 can transmit responses with available ride hailing service options. The language model 140 analyzes the responses to identify the cheapest ride hailing option (e.g., offered by Company B), and generates a multi-platform response 172 that identifies the option.

After the ride hailing option is displayed via the client interface 135 with related parameters (e.g., identifying the company, price, pickup time, etc.), the end-user provides an input declining the ride hailing option and indicating a preference for a ride with a quicker pickup time. The language model 140 analyzes the input to discern the intent of the end-user and transmits a second set of user-specific requests to the service provider platforms 180 to obtain alterative ride share options with shorter pickup times. Upon receiving a listing of ride hailing options from the service provider platforms 180, the language model 140 generates an output for a second ride hailing option with a shorter pickup time (e.g., offered by Company A). In response to the end-user providing an input indicating acceptance of the alternative ride hailing option, the language model 140 communicates with the corresponding service provider platform 180 and transmits a message or command to place an order for the alternative ride share option.

FIG. 5C shows example in which an end-user interacts with the language model 140 to obtain information relating to lodging services (e.g., which can include hotel booking services). In this example, the end-user submits a user request 171 via the client interface 135 requesting pricing information on hotels located in the vicinity of the end-user. The language model 140 analyzes the user request 17 to discern the intent of the end-user and requests additional information to respond to the user request 171. Specifically, because the language model 140 was pre-trained on a domain-specific dataset that enables it to understand that hotel pricing can vary based on a desired timeframe, the language model 140 requests the end-user confirm that a hotel room is desired for the current night. In response to receiving an input affirming that a room is needed for the current night, the language model 140 generates and transmits a user-specific request to each of plurality of service provider platforms 180 that provide hotel booking services.

Before transmitting the requests, the language model 140 may compare the location of the end-user to the locations of hotels to identify a subset of hotels located near the end-user. In certain embodiments, the end-user location can be obtained from the end-user's computing device 110 and/or a location application stored on the computing device 110, while the hotel locations can be obtained from the communication exchange with the service provider platforms 180. The language model 140 can then interact with service provider platforms 180 associated with the nearby hotels to obtain service options 195 corresponding to available hotel rooms. The language model 140 can then generate a multi-platform response 172 summarizing the service options 195, and the multi-platform response 172 can be output to the end-user via the client interface 135. In response to the end-user's selection of a service option 195, the language model 140 can transmit a message or command to the corresponding service provider platform 180 to reserve the room corresponding to the selected service option 195.

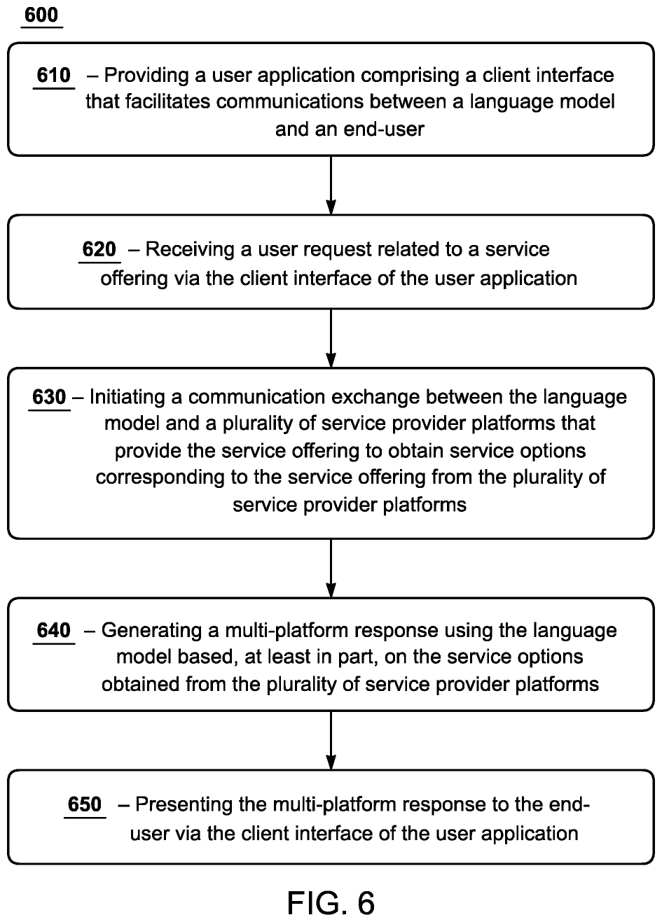

FIG. 6 illustrates a flow chart for an exemplary method 600 according to certain embodiments. Method 600 is merely exemplary and is not limited to the embodiments presented herein. Method 600 can be employed in many different embodiments or examples not specifically depicted or described herein. In some embodiments, the steps of method 600 can be performed in the order presented. In other embodiments, the steps of method 600 can be performed in any suitable order. In still other embodiments, one or more of the steps of method 600 can be combined or skipped. In many embodiments, system 100, user application 130 and/or application platform 150 can be configured to perform method 200 (e.g., process flow 200) and/or one or more of the steps of method 600. In these or other embodiments, one or more of the steps of method 600 can be implemented as one or more computer instructions configured to run at one or more processing devices 102 and configured to be stored at one or more non-transitory computer storage devices 101. Such non-transitory memory storage devices 101 can be part of a computer system such as system 100, user application 130 and/or application platform 150.

In step 610, a user application 130 is provided comprising a client interface 135 that facilitates communications between a language model 140 and an end-user. In some cases, the client interface 135 can be provided via a front-end of the user application 130 and language model 140 can be hosted on a remote server 120 (e.g., a server 120 that hosts a back-end of the user application 130 and/or a separate server 120 that hosts the language model 140).

In step 620, a user request 171 is received via the client interface 135 relating to a service offering 190. The user request 171 can include a text and/or voice-based input received from an end-user. The user request 171 can relate to any type of service offering 190 (e.g., ride hailing services, online marketplaces, lodging booking services, restaurant reservation services, parking reservation services, ticket booking services, etc.).

In step 630, a communication exchange is initiated between the language model and a plurality of service provider platforms 180 that provide the service offering 190 to obtain service options 195 corresponding to the service offering 190 from the plurality of service provider platforms 180. Depending on the subject of the user request 171, the service options 195 can corresponding to options for scheduling rides, order products, reservation times, etc.

In step 640, a multi-platform response 172 is generated using the language model based, at least in part, on the service options 195 obtained from the plurality of service provider platforms. The multi-platform response 172 may represent any response that is generated or derived, at least in part, from an analysis of data received from two or more service provider platforms 180. In some cases, the multi-platform response 172 generated by the language model language model 140 includes a single service option 195 determined or predicted to be optimal based on the user request 171. In other scenarios, the multi-platform response 172 can provide a summary of various service options 195.

In step 650, the multi-platform response 172 is presented to the end-user the via the client interface 135 of the user application 130. In some embodiments, the multi-platform response 172 can include interactive options that enable the end-user to place an order for one or more service options 195. Additionally, or alternatively, the end-user can provide a human language response to place an order for the one or more service options 195.

As evidenced by the disclosure herein, the inventive techniques set forth in this disclosure are rooted in computer technologies that overcome existing problems in known systems, including problems dealing with accessing and presenting service options corresponding to the service offerings from a plurality of separate service providers. The techniques described in this disclosure provide a technical solution (e.g., one that utilizes pre-trained AI chatbots or machine learning models) for overcoming the limitations associated with known techniques. This technology-based solution marks an improvement over existing capabilities and functionalities related to accessing and presenting service options by improving the manner in which the service options are obtained (e.g., by providing a language model that serves as an intermediary between an end-user and a plurality of service provider platforms).

In a number of embodiments, the techniques described herein can advantageously provide an improved user experience by enabling an end-user to communicate with an AI-chatbot or language model to quickly and easily identify, compare, and select service options offered by multiple service providers. These techniques provide a significant improvement over traditional systems that typically present require end-users to separately access and provide inputs into distinct service provider applications, and to manually compare service options.

Furthermore, in a number of embodiments, the techniques described herein can solve a technical problem that arises only within the realm of computer networks, because machine learning does not exist outside the realm of computer networks.

In certain embodiments, a method is implemented via execution of computing instructions by one or more processors and stored on one or more non-transitory computer-readable storage devices. The method comprises: providing a user application comprising a client interface that facilitates communications between a language model and an end-user; receiving, via the client interface of the user application, a user request related to a service offering; initiating a communication exchange between the language model and a plurality of service provider platforms to obtain service options corresponding to the service offering from the plurality of service provider platforms; generating, by the language model, a multi-platform response based, at least in part, on the service options obtained from the plurality of service provider platforms; and presenting, via the client interface of the user application, the multi-platform response to the end-user.

In certain embodiments, a system comprises one or more processors and one or more non-transitory computer-readable storage devices storing computing instructions configured to run on the one or more processors and cause the one or more processors to execute functions comprising: providing a user application comprising a client interface that facilitates communications between a language model and an end-user; receiving, via the client interface of the user application, a user request related to a service offering; initiating a communication exchange between the language model and a plurality of service provider platforms to obtain service options corresponding to the service offering from the plurality of service provider platforms; generating, by the language model, a multi-platform response based, at least in part, on the service options obtained from the plurality of service provider platforms; and presenting, the via the client interface of the user application, the multi-platform response to the end-user.

In certain embodiments, a method is implemented via execution of computing instructions by one or more processors and stored on one or more non-transitory computer-readable storage devices. The method comprises: providing a user application comprising a client interface that facilitates communications between a language model and an end-user; initiating a communication exchange between the language model and a plurality of service provider platforms to obtain service options corresponding to a service offering from the plurality of service provider platforms; generating, by the language model, a multi-platform response based, at least in part, on the service options obtained from the plurality of service provider platforms; and presenting, the via the client interface of the user application, the multi-platform response to the end-user.

Embodiments may include a computer program product accessible from a computer-usable or computer-readable medium providing program code for use by or in connection with a computer or any instruction execution system. A computer-usable or computer-readable medium may include any apparatus that stores, communicates, propagates, or transports the program for use by or in connection with the instruction execution system, apparatus, or device. The medium can be a magnetic, optical, electronic, electromagnetic, infrared, or semiconductor system (or apparatus or device) or a propagation medium. The medium may include a computer-readable storage medium, such as a semiconductor or solid-state memory, magnetic tape, a removable computer diskette, a random access memory (RAM), a read-only memory (ROM), a rigid magnetic disk and an optical disk, etc.

A data processing system suitable for storing and/or executing program code may include at least one processor coupled directly or indirectly to memory elements through a system bus. The memory elements can include local memory employed during actual execution of the program code, bulk storage, and cache memories that provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modems, and Ethernet cards are just a few of the currently available types of network adapters.

It should be recognized that any features and/or functionalities described for an embodiment in this application can be incorporated into any other embodiment mentioned in this disclosure. Moreover, the embodiments described in this disclosure can be combined in various ways. Additionally, while the description herein may describe certain embodiments, features, or components as being implemented in software or hardware, it should be recognized that any embodiment, feature, or component that is described in the present application may be implemented in hardware, software, or a combination of the two.

While various novel features of the invention have been shown, described, and pointed out as applied to particular embodiments thereof, it should be understood that various omissions and substitutions, and changes in the form and details of the systems and methods described and illustrated, may be made by those skilled in the art without departing from the spirit of the invention. Amongst other things, the steps in the methods may be carried out in different orders in many cases where such may be appropriate. Those skilled in the art will recognize, based on the above disclosure and an understanding of the teachings of the invention, that the particular hardware and devices that are part of the system described herein, and the general functionality provided by and incorporated therein, may vary in different embodiments of the invention. Accordingly, the description of system components are for illustrative purposes to facilitate a full and complete understanding and appreciation of the various aspects and functionality of particular embodiments of the invention as realized in system and method embodiments thereof. Those skilled in the art will appreciate that the invention can be practiced in other than the described embodiments, which are presented for purposes of illustration and not limitation. Variations, modifications, and other implementations of what is described herein may occur to those of ordinary skill in the art without departing from the spirit and scope of the present invention and its claims.

1. A method implemented via execution of computing instructions by one or more processors and stored on one or more non-transitory computer-readable storage devices, the method comprising:
providing a user application comprising a client interface that facilitates communications between a language model and an end-user;
receiving, via the client interface of the user application, a user request related to a service offering;
initiating a communication exchange between the language model and a plurality of service provider platforms to obtain service options corresponding to the service offering from the plurality of service provider platforms, wherein each service provider platform is hosted on one or more servers and each of the plurality of service provider platforms provide a separate service provider application associated with the service offering;
generating, by the language model, a multi-platform response based, at least in part, on the service options obtained from the plurality of service provider platforms; and
presenting, via the client interface of the user application, the multi-platform response to the end-user.

2. The method of claim 1, wherein the language model includes a generative pre-trained transformer (GPT) model that is configured to interpret the user request received via the client interface, communicate with the each of the plurality of service provider platforms in connection with the user request, and generate the multi-platform response in a human language format based, at least in part, on responses received from the plurality of service provider platforms.

3. The method of claim 1, wherein:
the language model is configured to analyze responses received from the plurality of service provider platforms to determine or predict a service option that is optimal based on the user request; and
the multi-platform response generated by the language model includes the service option determined or predicted to be optimal based on the user request.

4. The method of claim 1, wherein the multi-platform response generated by the language model summarizes the service options obtained from the plurality of service provider platforms.

5. The method of claim 1, wherein:
the multi-platform response generated by the language identifies at least one service option corresponding to the service offering; and
the end-user can communicate with the language model to schedule, or place an order for, the at least one service option.

6. The method of claim 5, wherein:
in response to receiving a user selection corresponding to the at least one service option, the language model communicates with at least one of the plurality of service provider platforms to schedule, or place an order for, the at least one service option corresponding to the service offering.

7. The method of claim 1, wherein the language model is pre-trained on a domain-specific dataset that includes textual content related to the service offering.

8. The method of claim 1, wherein:
the multi-platform response is generated based, at least in part, using one or more user preferences learned by the language model from previous interactions with the end-user; and
the language model includes a continuous learning framework that enables the language model to learn the one or more user preferences.

9. The method of claim 1, wherein the language model is configured to utilize learned activity patterns of the end-user to preemptively communicate with the end-user via the client interface.

10. The method of claim 1, wherein:
the service offering identified in the user request is related to a ride hailing service offering;
the plurality of service provider platforms offer the ride hailing service offering;
the service options correspond to ride hailing service options; and
the multi-platform response identifies one or more of the ride hailing service options based on the user request.

11. A system comprising:
one or more processors; and
one or more non-transitory computer-readable storage devices storing computing instructions configured to run on the one or more processors and cause the one or more processors to execute functions comprising:
providing a user application comprising a client interface that facilitates communications between a language model and an end-user;
receiving, via the client interface of the user application, a user request related to a service offering;
initiating a communication exchange between the language model and a plurality of service provider platforms to obtain service options corresponding to the service offering from the plurality of service provider platforms, wherein each service provider platform is hosted on one or more servers and each of the plurality of service provider platforms provide a separate service provider application associated with the service offering;
generating, by the language model, a multi-platform response based, at least in part, on the service options obtained from the plurality of service provider platforms; and
presenting, the via the client interface of the user application, the multi-platform response to the end-user.

12. The system of claim 11, wherein the language model includes a generative pre-trained transformer (GPT) model that is configured to interpret the user request received via the client interface, communicate with the each of the plurality of service provider platforms in connection with the user request, and generate the multi-platform response in a human language format based, at least in part, on responses received from the plurality of service provider platforms.

13. The system of claim 11, wherein:
the language model is configured to analyze responses received from the plurality of service provider platforms to determine or predict a service option that is optimal based on the user request; and
the multi-platform response generated by the language model includes the service option determined or predicted to be optimal based on the user request.

14. The system of claim 11, wherein the multi-platform response generated by the language model summarizes the service options obtained from the plurality of service provider platforms.

15. The system of claim 11, wherein:
the multi-platform response generated by the language identifies at least one service option corresponding to the service offering;
the end-user can communicate with the language model to schedule, or place an order for, the at least one service option; and
in response to receiving a user selection corresponding to the at least one service option, the language model communicates with at least one of the plurality of service provider platforms to schedule, or place an order for, the at least one service option corresponding to the service offering.

16. The system of claim 11, wherein the language model is pre-trained on a domain-specific dataset that includes textual content related to the service offering.

17. The system of claim 11, wherein:
the multi-platform response is generated based, at least in part, using one or more user preferences learned by the language model from previous interactions with the end-user; and
the language model includes a continuous learning framework that enables the language model to learn the one or more user preferences.

18. The system of claim 11, wherein the language model is configured to utilize learned activity patterns of the end-user to preemptively communicate with the end-user via the client interface.

19. A method implemented via execution of computing instructions by one or more processors and stored on one or more non-transitory computer-readable storage devices, the method comprising:
providing a user application comprising a client interface that facilitates communications between a language model and an end-user;
initiating a communication exchange between the language model and a plurality of service provider platforms to obtain service options corresponding to a service offering from the plurality of service provider platforms, wherein each service provider platform is hosted on one or more servers and each of the plurality of service provider platforms provide a separate service provider application associated with the service offering;
generating, by the language model, a multi-platform response based, at least in part, on the service options obtained from the plurality of service provider platforms; and
presenting, the via the client interface of the user application, the multi-platform response to the end-user.

20. The method of claim 19, wherein:
the multi-platform response is generated in response to receiving a user request via the client interface of the user application; or
the multi-platform response is generated, at least in part, by a preemptive analysis function without being prompted by the end-user.
